(19) United States
(12) Patent Application Publication
(10) Pub. No.: US 2026/0323261 A1
(43) Pub. Date: Oct. 15, 2026

(54) DEVICE FOR OPERATING A VEHICLE

(71) Applicant: NISSAN NORTH AMERICA, INC., Franklin, TN (US)

(72) Inventor: Burak DURIG, Farmington Hill, MI (US)

(21) Appl. No.: 19/176,062

(22) Filed: Apr. 10, 2025

(51) Int. Cl. H04W 4/44; B60K 35/10; B60K 35/22

(52) U.S. Cl. CPC H04W 4/44; B60K 35/10; B60K 35/22

(57) ABSTRACT

A device for operating a vehicle includes a first communication device, a second communication device and an electronic controller. The first communication device connects to a remote server. The second communication device connects a vehicle control system of a vehicle. The electronic controller downloads information from the remote server through the first communication device and provides the information to the vehicle control device through the second communication device, and operates an aspect of the vehicle by sending an electronic control signal to the vehicle control system.

### BACKGROUND

### Technical Field

The present disclosure generally relates to a device for operating a vehicle. More specifically, the present disclosure relates to a device that is capable of operating a vehicle and providing a unique experience for each user of the vehicle.

### Background Information

Conventional key fobs operate aspects of the vehicle, such as unlocking doors, opening doors and providing authorization for operation of the vehicle. As can be understood, conventional key fobs can be considered remote keyless entry systems and can use radio frequency identification (RFID) to transmit coded signals to a vehicle's receiver, allowing users to lock, unlock, and start a car remotely.

### SUMMARY

It has been determined that an improved device to operate a vehicle and provide a unique user experience is desired.

In view of the state of the known technology, one aspect of the present disclosure is to provide a device for operating a vehicle includes a first communication device, a second communication device and an electronic controller. The first communication device connects to a remote server. The second communication device connects a vehicle control system of a vehicle. The electronic controller downloads information from the remote server through the first communication device and provides the information to the vehicle control device through the second communication device, and operates an aspect of the vehicle by sending an electronic control signal to the vehicle control system.

Another aspect of the present disclosure provides a method of operating a vehicle, the method comprising operating a device, downloading information from a remote server using a first communication device of the device, connecting the device to a vehicle, providing the information to a vehicle control device using a second communication device, sending a control signal from the device to operate an aspect of the vehicle.

By providing a device and method as disclosed herein a customizable experience for a user while still providing operation of aspects of the vehicle provided by conventional key fobs.

### BRIEF DESCRIPTION OF THE DRAWINGS

Referring now to the attached drawings which form a part of this original disclosure:

FIG. 1 illustrates a device according to one embodiment of the present invention being positioned adjacent to the coupling unit on the dashboard of the vehicle.

FIG. 2A is a perspective view of the device of FIG. 1.

FIG. 2B is a front elevational view of the device of FIG. 1.

FIG. 2C is a bottom view of the device of FIG. 1.

FIG. 2D is an elevational side view of the device of FIG. 1.

FIG. 2E is a top view of the device of FIG. 1.

FIG. 3 is a schematic view of the device of FIG. 1 and its communication with a remote server in a cloud.

FIG. 4 is a schematic view of the device of FIG. 1 and its communication with a vehicle.

FIG. 5 is a schematic view of the downloading of individual user experience for operation of the device of FIG. 1.

FIG. 6 illustrates one process of providing a unique user experience.

FIG. 7 illustrates another process of providing a unique user experience.

FIG. 8 illustrates another process of providing a unique user experience.

FIG. 9 illustrates another process of providing a unique user experience.

FIG. 10 illustrates the process of providing multiple users with a unique user experience.

It should be noted that these figures are intended to illustrate the general characteristics of methods, structure and/or materials utilized in certain illustrative embodiments and to supplement the written description provided below. These drawings are not to scale and may not precisely reflect the precise structural or performance characteristics of any given embodiment and should not be interpreted as defining or limiting the range of values or properties encompassed by illustrative embodiments unless specified.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the disclosure as defined by the appended claims and their equivalents.

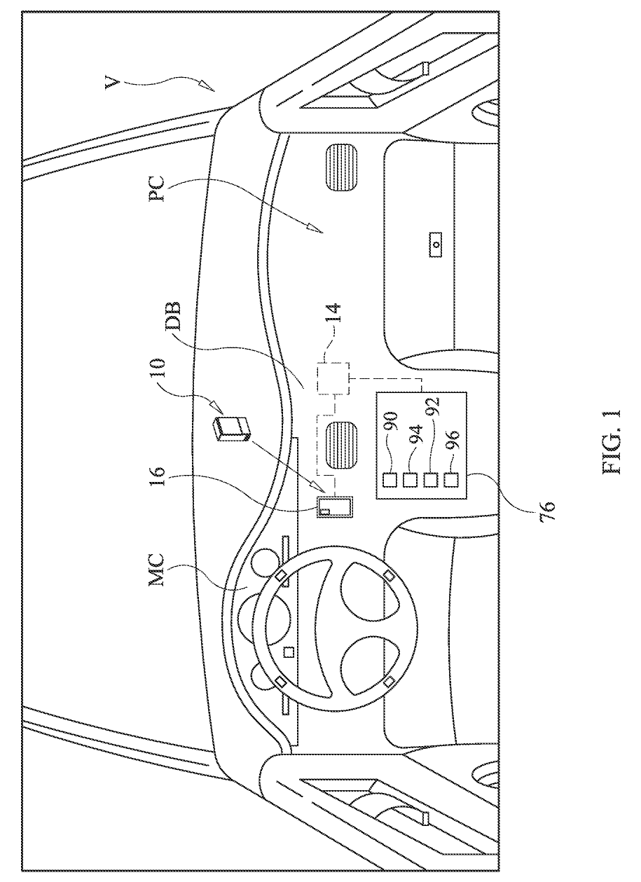

Referring initially to FIGS. 1-4, a device 10 is illustrated in accordance with a first embodiment. The device 10 is configured to communicate with a remote server 12 in the cloud and a vehicle control system 14 disposed within a vehicle V. As illustrated in one embodiment, the device 10 is configured to communicate with a vehicle control system 14 by attaching to a coupling unit 16 on the dashboard DB of the vehicle V. It can be understood that even though the device 10 is illustrated as physically connected to the coupling unit 16 of the dashboard DB of the vehicle V, the device 10 can wireless communicate with the vehicle control system 14 and/or be coupled to the coupling unit 16 in any manner or in any location in the vehicle V.

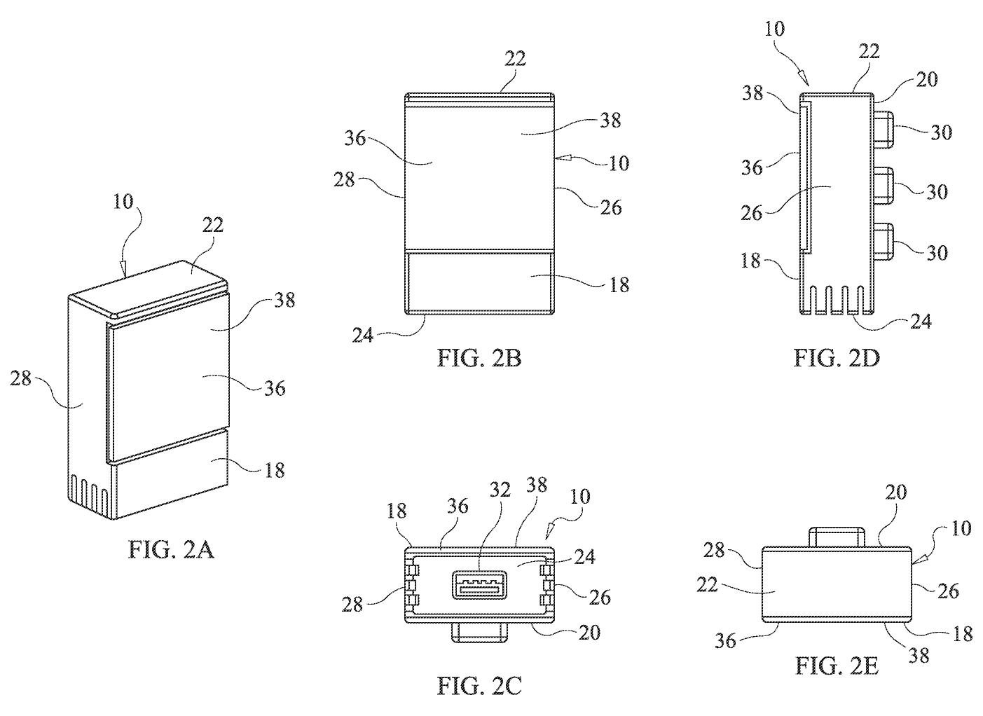

As illustrated in FIGS. 2A-2E, the device 10 (artifact) can be a rectangular device 10 and formed from a plastic material. The device 10 includes a front side 18, a rear side 20, a top side 22, a bottom side 24 and a left side 26 and a right side 28. The device 10 includes a plurality of buttons 30 on the rear side 20 and are configured to control aspects of the vehicle V. In one embodiment, the plurality of button 30 includes three (3) buttons and can be used for any suitable operation, such a locking/unlocking the vehicle V, remote starting the vehicle V and/or operating the horn/alarm of the vehicle V, As can be understood, the buttons can operate any aspect of vehicle operation, such as opening a door, operating an aspect in the passenger compartment as is known in the art.

In one embodiment, the device 10 can be sized and configured to be palm sized or smaller. That is, the device 10 is configured to fit within a pocket of a user or within a carry bag or other receptacle. The device 10 is configured to be or sufficiently sized to enable easy operation of any buttons and/or switches and for view the display unit 36, while remaining small enough to easily carry.

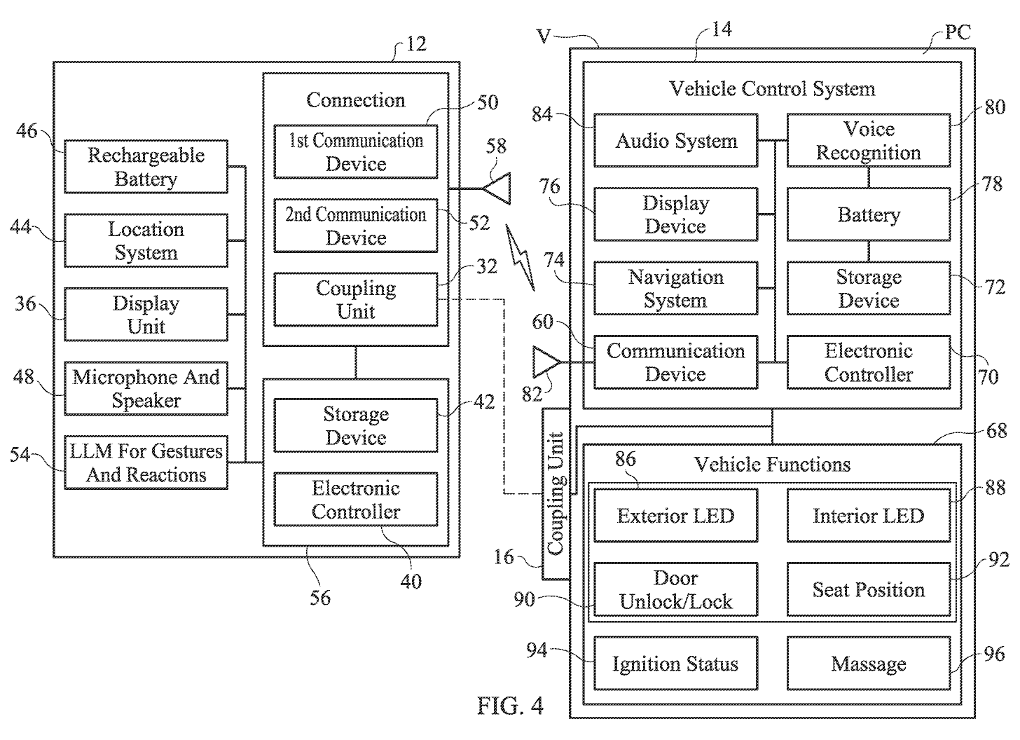

A coupling unit 32 is disposed on the bottom side 24 and is configured to couple to the coupling unit 16 on the dashboard DB of the vehicle V. The coupling unit 32 can be a USB-A,USB-B,USB-C or any other suitable connection that enables information to be transferred from the device 10 to the vehicle control system 14. As illustrated in FIGS. 1 and 4 the device 10 is physically connected to the coupling unit 16 on the dashboard DB of the vehicle V.

The device 10 further includes a display unit 36 to display information and user specific displays. As illustrated in FIGS. 2A and 2D, the display unit 36 is disposed on the opposite side of the device 10 from the plurality of buttons 30 and 90 degrees offset from the bottom side 24 of the device 10, see for example FIG. 2C and 2D. The display unit 36 can be a display that is capable of displaying information. As described herein, the information that is displayed can be at least one of status information of related to the vehicle V as is known in the art. Preferably, the display unit 36 includes an input 38. The input 38 in this embodiment can be touch screen (or a user interface UI). Thus, in one embodiment, the display unit 36 can function as user interface. The display unit 36 and/or the input 38 can include a graphical operator interface (GUI) to enable a user to change settings in the vehicle V, operate the device 10 and provide any information input necessary for operation of the vehicle V and the vehicle control system 14. As can be understood, input 38 is configured to enable operation of the vehicle V or a feature 68 of the vehicle V.

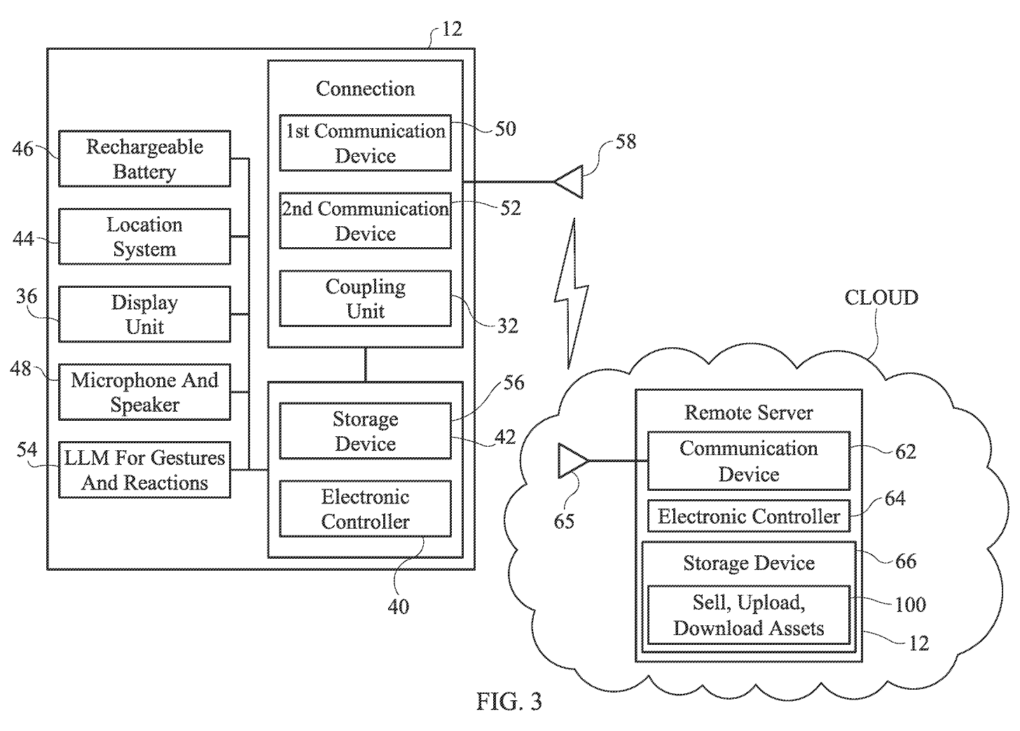

As illustrated in FIGS. 3 and 4, the device 10 can also include an electronic controller 40, a storage device 42, a location system (GPS) 44, a battery 46, a microphone and speaker 48, a first communication device 50, a second communication device 52 and a large language module (LLM) 54 for gesture and reaction recognition.

In the illustrated embodiment, the device 10 can include the electronic control unit or controller 40 (e.g., a processor) and the storage device 42. In one embodiment, the controller 40 and the storage device 42 can be part of an SoC 56 with memory. As can be understood an SoC (System-on-a-Chip) 56 integrates memory blocks, including RAM (SRAM and DRAM), Rom and flash memory, along with other components, such as processors and peripherals onto a single chip. It is noted that the controller 40 and the storage device 42 can be any suitable controller and storage device capable of performing the functions described herein and can be separate, combined, integral or have any other suitable configuration.

In one embodiment, the electronic controller 40 includes one or more processor(s) for controlling the various operations of the device 10, as will be further described. In the illustrated embodiment, the electronic controller 40 is preferably a microcomputer (MPU) or central processing unit (CPU). The electronic controller 40 is formed of one or more semiconductor chips that are mounted on a circuit board. The term “electronic control unit” or “electronic controller” as used herein refers to hardware that executes a software program, and does not include a human being. The MPU or CPU can be one or more integrated circuits having firmware for causing the circuitry to complete the activities described herein. Of course, any number of other analog and/or digital components capable of performing the functionality described below can be provided in place of, or in conjunction with the electronic controller 40.

The storage device 42 is any memory or computer memory. Here, for example, the storage device 42 includes a transitory or non-transitory computer-readable medium with the sole exception of a transitory propagating signal. Thus, the storage device 42 can include nonvolatile memory and volatile memory, and can include at least one of an internal memory, or other type of memory devices such as a read-only memory (ROM), an erasable programmable read only memory (EPROM), an electrically erasable programmable read-only memory (EEPROM), a random access memory (RAM), a hard disk, a flash drive, etc. The storage device 42 stores various control processes or control programs as well as information or data used by the electronic controller 40. Thus, the storage device 42 is electrically connected to the electronic controller 40. In this way, the electronic controller 40 can retrieve data and access programs stored in the storage device 42, and can store data to the storage device 42. As explained below, the storage device 42 preferably includes non-volatile memory that is configured to store various control programs (e.g., a program for a vehicle V control method, etc.), operational data, component identification data, etc.

In the illustrated embodiment, the storage device 42 is configured to store at least one reference image or series of images associated with a customizable user experience. More particularly, the storage device 42 is configured to store a plurality of images associated with the customizable user experience. For example, the storage device 42 can store images or videos of characters or other images or videos that are desired to be displayed by the user.

The storage device 42 can also store non-transitory computer readable media (e.g., audio, image and video files), computer program instructions or software, preference information, device 10 profile information, and any other suitable data. The storage device 42 can be used to retain computer program instructions or code organized into one or more modules and written in any desired computer programming language. The processor of the electronic controller 40 can execute such computer program code by implementing one or more of the methods described herein.

The location system 44 includes a global location satellite system (GNSS) receiver. In the illustrated embodiment, the GNSS receiver can be a global positioning system (GPS) receiver, for example. The location system 44 receives radio waves from a plurality of navigation satellites to obtain information that represents, for example, a current heading of the device 10, a current position of the device 10 in two or three dimensions, a current angular orientation of the device 10, or a combination thereof.

The battery 46 can be any suitable self-contained device that is configured to provide power to the device 10. In one embodiment, the battery 46 is a rechargeable lithium-ion battery 46 that is connected to the coupling unit 32 and is configured to be charged while the device 10 is connected to the coupling unit 16 of the vehicle V. In this embodiment, the vehicle V is able to charge the battery 46 using the vehicle electrical system. As can be understood, the battery 46 can be any type of battery 46 or any type of power supply device 10.

The first communication device 50 can be a wireless communicator in wireless communications with at least one of cloud services (e.g., remote server 12). The first communication device 50 can be a hardware device capable of transmitting and/or receiving an analog or digital signal wirelessly via the antenna 58. The term “communication device” as used herein include a receiver, a transmitter, a transceiver, or a transmitter-receiver, for example. The first communication device 50 is capable of transmitting and/or receiving wireless communication signals, including control, command or other signals related to a function of the component being controlled. In one embodiment the first communication device 50 is configured to transmit and receive through a Wi-Fi network, or using a cellarer network, a satellite network or any other type of communications system or network that would enable long range communications and/or communications with the remote server 12 in the cloud. Here, the wireless first communication device 50 can be a two-way wireless communication unit having a receiver and a transmitter.

The second communication device 52 can be a short range communication device configured to be in communication with the vehicle V. The second communication device 52 can be a hardware device capable of transmitting and/or receiving an analog or digital signal wirelessly via an antenna 58. The term “communication device” as used herein include a receiver, a transmitter, a transceiver, or a transmitter-receiver, for example. The second communication device 52 is capable of transmitting and/or receiving wireless communication signals, including control, command or other signals related to a function of the component being controlled. The wireless communication signals can be radio frequency (RF) signals, ultra-wide band communication signals, near field communications or Bluetooth communications or any other type of signal suitable for wireless communications as understood in the field. Here, the second communication device 52 can be a two-way wireless communication unit having a receiver and a transmitter.

As disclosed herein, the first and second wireless communicators 50 and 52 can use the same antenna 58 to transmit and receive wireless signals. However, it is noted that the first and second wireless communicators 50 and 52 can have separate antennas or communicate in any reasonable manner.

In one embodiment, when the device 10 is coupled to the vehicle through the coupling units 16 and 32, communication can be transmitted through the coupling unit 32. In other words, either or both of the communication that occurs with the first and second wireless communicators 50 and 52 can occur through the coupling units 16 and 32. In this embodiment, the device 10 can communicate with the vehicle control system 14 through the coupling units 16 and 32. Furthermore, as discussed in more detail below, the vehicle V includes a communication device 60 that is capable of communicating with the cloud, such that the device 10 can download information from the cloud using the communication device 60 in the vehicle V.

As can be understood, an LLM 54 for gesture and reaction recognition enables the device 10 to recognize hand gestures in real time, and provides the recognized hand gesture results along with the landmarks of the detected hands. You can use this task to recognize specific hand gestures from a user, and invoke application features that correspond to those gestures. LLM 54 for gesture and reaction recognition operates on image data with a machine learning (ML) model, and accepts either static data or a continuous stream. The task outputs hand landmarks in image coordinates, hand landmarks in world coordinates, handedness (left/right hand), and the hand gesture categories of multiple hands.

The speaker and microphone 48 in the device 10 can be any suitable speaker and microphone 48. As can understood, the microphone enables a user to input audio information into the device 10 and the device 10 is capable of playing user specific or generic sounds through the speaker 48.

As illustrated in FIG. 3, the remote server 12 includes an electronic controller 64, a storage device 66 and a wireless communicator 62. The electronic controller 64 includes one or more processor(s) for controlling the various operations of the device 10, as will be further described. In the illustrated embodiment, the electronic controller 64 is preferably a microcomputer (MPU) or central processing unit (CPU). The electronic controller 64 is formed of one or more semiconductor chips that are mounted on a circuit board. The term “electronic control unit” or “electronic controller 40” as used herein refers to hardware that executes a software program, and does not include a human being. The MPU or CPU may be one or more integrated circuits having firmware for causing the circuitry to complete the activities described herein. Of course, any number of other analog and/or digital components capable of performing the functionality described below can be provided in place of, or in conjunction with the electronic controller 64.

The storage device 66 is any memory or computer memory. Here, for example, the storage device 66 includes a transitory or non-transitory computer-readable medium with the sole exception of a transitory propagating signal. Thus, the storage device 66 can include nonvolatile memory and volatile memory, and can include at least one of an internal memory, or other type of memory devices such as a read-only memory (ROM), an erasable programmable read only memory (EPROM), an electrically erasable programmable read-only memory (EEPROM), a random access memory (RAM), a hard disk, a flash drive, etc. The storage device 66 stores various control processes or control programs as well as information or data used by the electronic controller 64. Thus, the storage device 66 is electrically connected to the electronic controller 64. In this way, the electronic controller 64 can retrieve data and access programs stored in the storage device 66, and can store data to the storage device 66. As explained below, the storage device 66 preferably includes non-volatile memory that is configured to store various control programs (e.g., a program for a vehicle V control method, etc.), operational data, component identification data, etc.

In the illustrated embodiment, the storage device 66 is configured to store at information related to customizable user experiences that are downloadable to the device 10. More particularly, the storage device 66 is configured to store a plurality of customizable user experiences that are downloadable to the device 10.

The storage device 66 can also store non-transitory computer readable media (e.g., audio, image and video files), computer program instructions or software, preference information, device profile information, and any other suitable data. The memory and/or the storage can be used to retain computer program instructions or code organized into one or more modules and written in any desired computer programming language. The processor of the electronic controller 64 can execute such computer program code by implementing one or more of the methods described herein.

The communication device 62 can be a hardware device capable of transmitting and/or receiving an analog or digital signal wirelessly via an antenna 65. The terms “communication device” as used herein include a receiver, a transmitter, a transceiver, or a transmitter-receiver, for example. The communication device 62 is capable of transmitting and/or receiving wireless communication signals, including control, command or other signals related to a function of the component being controlled. The wireless communication signals can be radio frequency (RF) signals, ultra-wide band communication signals, or Bluetooth communications or any other type of signal suitable for wireless communications as understood in the field. Here, the communication device 62 can be a two-way wireless communication unit having a receiver and a transmitter.

As illustrated in FIG. 4, the vehicle V includes a vehicle control system 14 and several vehicle functions 68. The vehicle control system 14 includes an electronic controller 70, a storage device 72, a communication device 60, a navigation system 74, a display device 76, a battery 78, a voice recognition system 80 and an audio system 84.

The electronic controller 70 includes one or more processor(s) for controlling the various operations of the vehicle V. In the illustrated embodiment, the electronic controller 70 is preferably a microcomputer (MPU) or central processing unit (CPU). The electronic controller 70 is formed of one or more semiconductor chips that are mounted on a circuit board. The term “electronic control unit” or “electronic controller” as used herein refers to hardware that executes a software program, and does not include a human being. The MPU or CPU may be one or more integrated circuits having firmware for causing the circuitry to complete the activities described herein. Of course, any number of other analog and/or digital components capable of performing the functionality described below can be provided in place of, or in conjunction with the electronic controller 70.

The storage device 72 is any memory or computer memory. Here, for example, the storage device 72 includes a transitory or non-transitory computer-readable medium with the sole exception of a transitory propagating signal. Thus, the computer memory 72 can include nonvolatile memory and volatile memory, and can include at least one of an internal memory, or other type of memory devices such as a read-only memory (ROM), an erasable programmable read only memory (EPROM), an electrically erasable programmable read-only memory (EEPROM), a random access memory (RAM), a hard disk, a flash drive, etc. The computer memory 72 stores various control processes or control programs as well as information or data used by the electronic controller 70. Thus, the storage device 72 is electrically connected to the electronic controller 70. In this way, the electronic controller 70 can retrieve data and access programs stored in the storage device 72, and can store data to the storage device 72. As explained below, the storage device 72 preferably includes non-volatile memory that is configured to store various control programs (e.g., a program for a vehicle V control method, etc.), operational data, component identification data, etc.

The navigation system 74 includes a global navigation satellite system (GNSS) receiver. In the illustrated embodiment, the GNSS receiver can be a global positioning system (GPS) receiver, for example. The navigation system 74 receives radio waves from a plurality of navigation satellites to obtain information that represents, for example, a current vehicle heading of the vehicle, a current vehicle position of the vehicle in two or three dimensions, a current vehicle angular orientation of the vehicle, or a combination thereof.

The communication device 60 is in wireless communications with at least one of cloud services and a vehicle network. The communication device 60 is a hardware device capable of transmitting and/or receiving an analog or digital signal wirelessly via an antenna 82. The terms “wireless communicator” as used herein include a receiver, a transmitter, a transceiver, or a transmitter-receiver, for example. The wireless communication signals can be radio frequency (RF) signals, ultra-wide band communication signals, or Bluetooth communications or any other type of signal suitable for wireless communications as understood in the field. As can be understood, the communication device 60 can operate to transmit information over the air (OTA).

The audio system 84 includes both internal speakers and external speakers (not shown). The internal speakers are positioned within the passenger compartment PC and are disposed to provide sounds to the passenger compartment PC. The internal speakers are configured to be controlled by the electronic controller 70 and play a sound package that has been downloaded by the vehicle V or a user to the computer memory 72. The external speakers are positioned on the vehicle V and are disposed to provide sounds to the exterior of the vehicle V. The external speakers are configured to be controlled by the electronic controller 70 and play a sound package that has been downloaded by the vehicle V or a user to the computer memory 72.

The display device 76 can be a display that is capable of displaying information. As described herein, the information that is displayed can be at least one of status information of related to the vehicle V as is known in the art. Preferably, the display device 76 includes an input. The input in this embodiment can be touch screen (or a user interface UI). The display device 76 can include a graphical operator interface (GUI) to enable a vehicle occupant to change settings in the vehicle V, operate the device 10 and provide any information input necessary for operation of the vehicle V and the vehicle control system 14.

The voice recognition system 80 receives and interprets dictation to understand spoken commands. The voice recognition system 80 enables users to interact with vehicle control system 14 simply by speaking to it, enabling hands-free requests, reminders and other simple tasks. As can be understood, voice recognition can identify and distinguish voices using automatic speech recognition (ASR) software programs.

The battery 78 can be any standard vehicle battery. The battery 78 can be a “starter battery” for an internal combustion engine or can be a battery or bank of batteries to operate an electric vehicle. The battery 78 is part of the electrical system that operates the electrical components in the vehicle V and is configured to charge the device 10 when the device 10 is coupled to connected to the coupling unit 16.

The vehicle V can include the vehicle functions 68. For example, the vehicle functions can include exterior LEDs 86, interior LEDs 88, door unlock/lock 90, seat position 92, ignition status 94 and/or message 96. The vehicle functions 68 can be any suitable or desired vehicle functions and are not limited to the examples discussed herein. As discussed in more detail below, the vehicle functions 68 can be customized by the user and operated by the device 10.

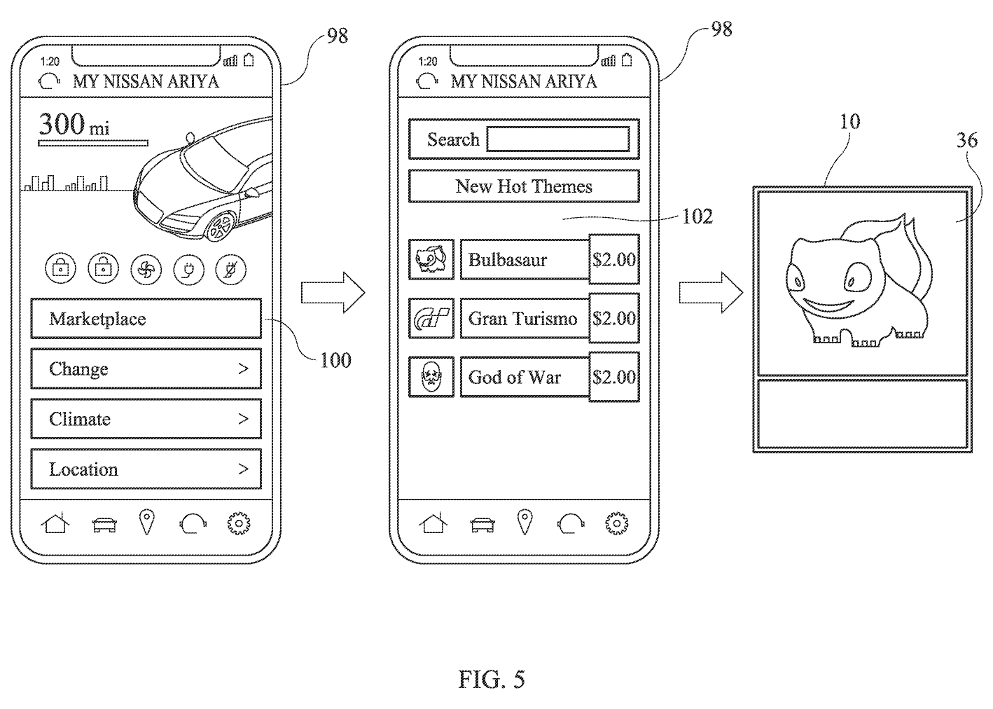

FIG. 5 illustrates one embodiment of providing customized information to the device 10. In this embodiment, a peripheral device 98, such a cell phone can be used to access a marketplace 100 that is stored in the remote server 12. The peripheral device 98 can be a tablet, a computer or any other suitable device to access the internet or a remote server 12 in any suitable manner. The marketplace 100 can be an app store that allows a user to access customizable information through an application (app). Here, the user can select the marketplace 100 from a plurality of options of the peripheral device 98. Within the marketplace option, the user can select a specific customizable information package 102. For example, the user can download a “Bulbasaur” package onto the device 10 through the peripheral device 98. The specific customizable information package 102 can be information that is a set of data selected among a plurality of sets of data. In other words, the customizable information package 102 can be one customizable information package among a plurality of customizable information packages

It is further noted that the device 10 can communicate directly with the remote server 12 through the first communication device 52. Thus, rather than having the peripheral device 98 download specific customizable information package, the device 10 can download the specific customizable information package.

The “Bulbasaur” package can include images and sounds related to “Bulbasaur” or any other Pokémon. The sounds can be played through the microphone and speaker 48 and the images can be displayed on the display unit 36. The customizable information package enables the user to provide a specific sound and image package to enhance the driving experience. For example, the user approaches the vehicle, the “Bulbasaur” package can cause specific sounds and/or images to be played by the microphone and speaker 48 and the display unit 36. As can be understood, the controller 40 of the device 10 can determine that the user is approaching the vehicle based on an interaction of the vehicle through the second communication device 52.

In addition, the sounds can be played through the audio system 84 and the images can be displayed on the display device 76 in the vehicle V. The customizable information package enables the user to provide a specific sound and image package to enhance the driving experience.

As can be understood, the peripheral device 98 can communicate with the remote server through the communication device 62. As is known in the art, the server can be authorized to download information (e.g., the “Bulbasaur” package) onto the peripheral device. The peripheral device 98 can then communicate with the device 10 to transfer the information (e.g., the “Bulbasaur” package) to the storage device 42.

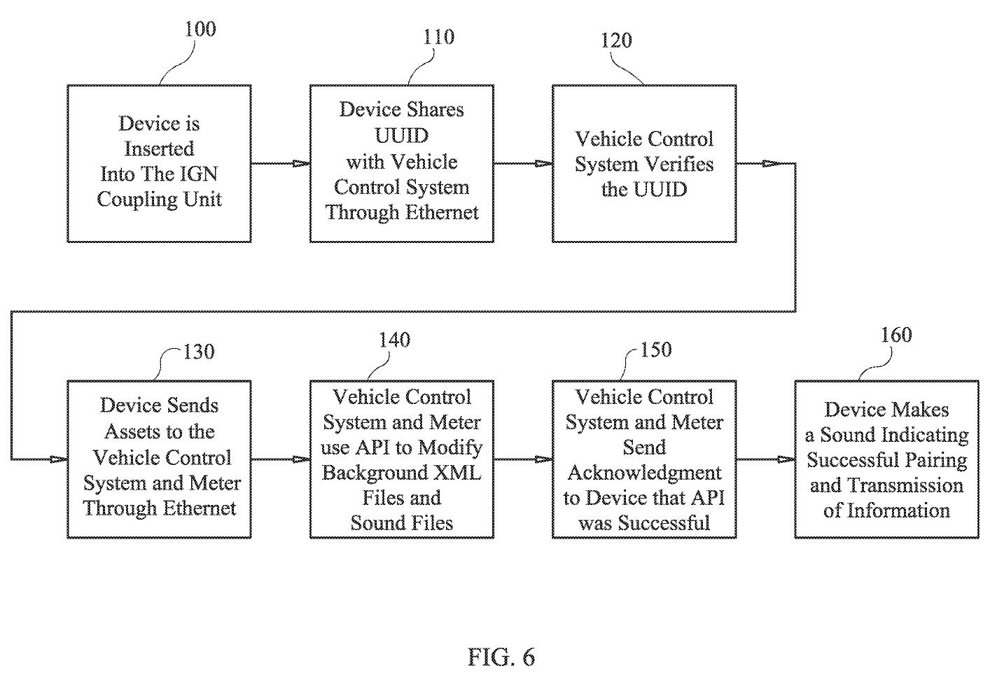

FIG. 6 illustrates a method of connecting or pairing the device 10 with vehicle control system 14 using the physical connecting between the coupling units 16 and 32. In step 100, the device 10 is inserted into the coupling unit 16. Here, the coupling unit 16 can be an ignition (IGN) switch coupling unit. As described herein, the coupling units 16 and 32 can be a USB connection or any other suitable connection. Moreover, the device 10 does not necessarily need to couple to the vehicle control system 14 through a physical connecting and can connect using a wireless connection. For example, as illustrated in FIG. 4, second communication device 52 can communicate with the communication device 60 in the vehicle V in any suitable manner. As discussed herein, the second communication device 52 can be a short range communication device configured to be in communication with the vehicle V. In this embodiment, the device 10 can use RFID to communicate with the vehicle once within range of the RFID communication signal. In step 110, the device 10 can share a universally unique identifier (UUID) with the vehicle control system 14 through the ethernet. In step 120, the vehicle control system 14 verifies that the UUID from the device 10. As can be understood the coupling units 16 and 32 enable the device 10 to connect with the vehicle control system 14 and provides authorization (through the UUID) to operate the vehicle V and aspects of the vehicle V.

In step 130, the device 10 sends the information (assets), including the customized or user specific information to the vehicle control system 14 and meter cluster MC. In step 140, based on the customized or user specific information, the vehicle control system 14 and meter cluster MC utilize the vehicle’s (e.g., Nissan) application programming interface (API) to modify the display device 76 (and meter) background XML files and sound files. That is, the vehicle control system 14 updates the display device 76 with personalized or customized images and sounds based on the information downloaded from the device 10. For example, the display device 76 in the vehicle can display Pokémon (e.g., Bulbasaur) images and provide corresponding sounds through the audio system 84. Moreover, in this embodiment, the control system 14 updates the meter cluster MC with personalized or customized images and sounds based on the information downloaded from the device 10. For example, the meter cluster MC in the vehicle V can display Pokémon (e.g., Bulbasaur) images and provide corresponding sounds through the audio system 84.

In step 150, the vehicle control system 14 and the meter cluster MC send an acknowledgement signal to the device 10 that the API was successful, and in step 160, the device 10 emits a sound that indicating successful pairing and transmission of the information (assets). In one embodiment, the sound is a customized sound unique to the user and provided in the information package downloaded to the device 10. In one embodiment, the sound is a generic sound. Further, the device 10 can provide a customized or unique image on the display unit 36 of the device 10, or any other image indicating that the pairing and transmission of the information was successful.

Thus, as illustrated in FIGS. 5 and 6, the device 10 is configured to operate the vehicle V or features of the vehicle V. for operating a vehicle. The first communication device 50 can connect to the remote server 12, and the second communication device 52 can connect the vehicle control system 14 of the vehicle V. The electronic controller 40 is configured to download information from the remote server 12 (either directly or through the peripheral device 98) and provide the information to the vehicle control device 14 through the second communication device 52, and configured to operate an aspect of the vehicle by sending an electronic control signal to the vehicle control system 14.

FIGS. 5 and 6 illustrate a method in which the vehicle V or a feature 68 of the vehicle is operated. First, the device 10 is operated. That is, as discussed in FIG. 5, the device 10 is operated to receive information using the first communication device 50 of the device 10. The device 10 can communicate directly with the remote server 12 or use the peripheral device 98 as an intermediary device. Then as described herein in FIG. 6, the device 10 is connected the vehicle using coupling units 16 and 32 or using the second communication device 52. As can be understood, the coupling unit 32 can be considered a communication device. Thus, the use of the terms first and second are merely exemplary and the first communication device can be a first, second or third communication device, the second communication device can be a first, second or third communication device and the coupling unit 32 can be a first, second or third communication device. The device is then connected to the vehicle V, and the information is provided to the vehicle control device 14 using the second communication device or the coupling unit 36. The device 10 can send a control signal from the device 10 to operate an aspect or feature 68 of the vehicle V.

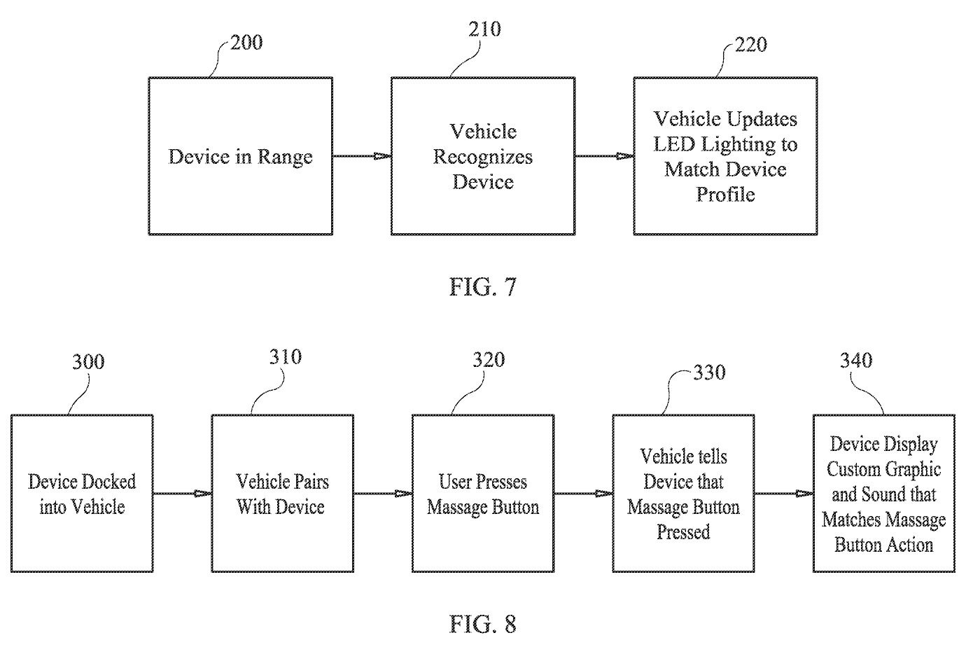

FIG. 7 illustrates a method of providing a customized approach for a user. In step 200, the device 10 is detected to be in range of the vehicle V. Such a determination can be made using, for example, the second communication device 52. As discussed herein, the second communication device 52 can be a short range communication device configured to be in communication with the vehicle V. In this embodiment, the device 10 can use RFID to communicate with the vehicle once within range of the RFID communication signal. It is noted that the device 10 can communicate with the vehicle in any manner disclosed herein and/or in any suitable manner. In step 210, the vehicle (or the vehicle control system 14) recognizes that the device 10. The transmission signal from the device 10 can be coded signal as is known in the art, such that the vehicle V will only respond to the signal from a specific or unique device 10.

Once the vehicle control system 14 recognizes the device 10 and vehicle control system 14 enables the vehicle V to update LED lighting for the vehicle C. In one embodiment, the exterior and/or the interior LED 86 and 88 lighting is updated. Furthermore, the LED lighting (Exterior LED 86 or interior LED) can be activated such that a customized LED lighting show or illumination is provided to the user as the user approaches the vehicle V.

Simultaneously, the vehicle control system 14 can provide a specific or customized sound for the user, as the user approaches the vehicle V. The vehicle control system 14 and further automatically control or operate any of the vehicle functions 68 when the device 10 approaches or comes within range of the vehicle V. For example, in addition to the light and sound emission that are personalized or customized for the user during approach of the vehicle V, the vehicle control system 14 can operate the seat to change the seat position 92 for a customized sitting position or a customized entry position. The vehicle control system 14 can also automatically remotely unlock the vehicle using the door unlock/lock 90 feature to provide access to the user.

These automatic control features enhance the user experience and use of the vehicle V by providing a personalized approach environment and providing a personalized vehicle driving set up.

FIG. 8 illustrates a method of providing a customized vehicle function for a user. In this embodiment, the device 10 can be docked with the vehicle V in step 300. That is, the coupling units 16 and 32 can be coupled together such that the device 10 is capable of communicating with the vehicle control system 14. In step 310, the vehicle (vehicle control system 14) pairs with the device 10. As described herein, the device 10 can provide a transmission of the user information. In step 320, the user presses a function button, such as the massage button (massage feature 96), the ignition status 94 or a seat position 92 button. In one embodiment, the function button is a button that is located in the vehicle V, for example, on the GUI of the display device 76. Alternatively, the button can be one of the plurality of buttons 30 on the device 10 itself. Accordingly, it can be understood that the plurality of buttons 30 are configured to operate the vehicle V or operate a feature 68 of the vehicle V.

In step 330, the vehicle control system 14 communicates with the device 10 through the second communication device 52 that the message button 96 on the display device 76 (GUI) or in the vehicle V has been operated. In step 340, the display unit 36 on the device 10 displays a custom image or graphic and a custom sound that corresponds to the button action. The sound can further be emitted from the audio system 84 in the vehicle V. The sound and the images (graphics) can produce lighting from both interior LED 88 and exterior LED 86, any sounds from the speaker 48 and/or the audio system 84 and provide any combination of customized experience desired.

As can be understood, the vehicle LEDs 86 and 88, and/or audio system 84 can provide customizable sounds and lights for a change in ignition status. In other words, the operation of the ignition (change in ignition status) can provide a customized engine sound or other sound desired by the user and also provide a customized light display desired by the user. These examples of customized sounds and displays are merely for an understanding of the operation and setting ability of the device 10 and are not meant to limit the displays and sounds that can be provided for any of the numerous vehicle functions 68 and operations known in the art.

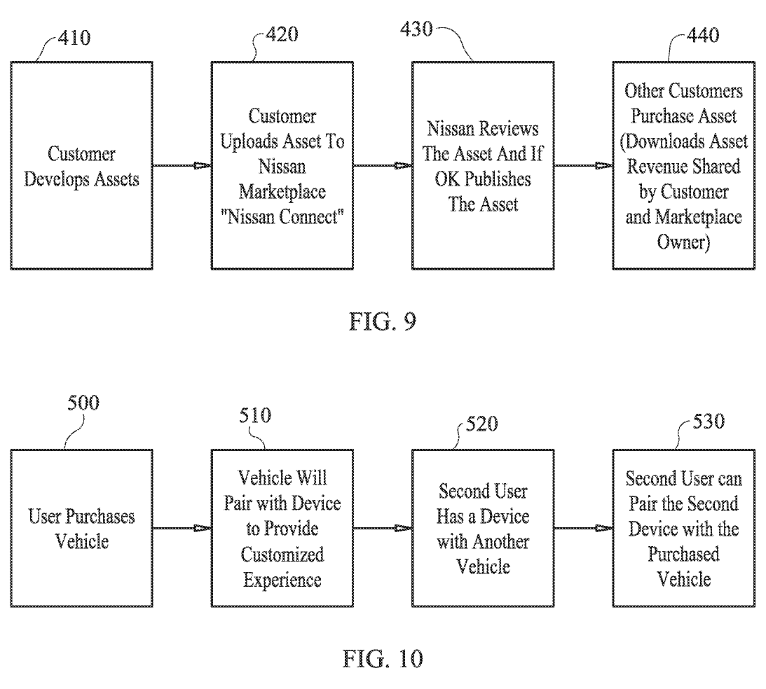

In FIG. 9, a method of providing customized information (assets) to the remote server 12 is illustrated. In this embodiment, a customer develops assets or information, in step 400. In step 410 the customer can upload the assets to the remote server 12 – e.g., the marketplace 100 or Nissan connect. While marketplace 100 (Nissan Marketplace) or Nissan connect are provided as examples of a remote server 12 onto which the assets can be uploaded, it will be understood that the assets can be uploaded to any suitable remote server or marketplace or any place in which the assets can be stored.

As can be understood, the assets are information, such as an application (app) that can be uploaded onto the server 12 in any suitable manner. For, example, the assets can be uploaded through any wireless or sired process.

In step 420, the assets can be reviewed for content. If the content is acceptable the remote server 12 can publish the assets. In this example, the assets are reviewed at the server by the owner (e.g., Nissan). The review can be automatic or manual. As can be understood, an automatic review will provide an improved system by decreasing review time and providing approval without the need for human interference.

In step 430, once the assets are published, the user (and others) can download the assets as information to the device 10, as described herein. In one embodiment, the user can provide currency to purchase the asset, the revenue of which can be shared by the remote server owner and the customer that developed the asset.

FIG. 10 illustrates a method of provided multiple customizable experience in the same vehicle. In step 500, the vehicle V is purchased by a user. In step 510, the vehicle V can be paired with the device 10 to provide a customized experience for the user, as described herein. In step 520 a second user can provide a second device 10 from a second vehicle. In step 530 the second user can pair the second device 10 with the vehicle V the user recently purchased. Thus, the two individual customized experiences for separate users can be provided in the same vehicle.

The vehicle functions 68 are conventional components that are well known in the art. Since the vehicle functions are well known in the art, these structures will not be discussed or illustrated in detail herein. Rather, it will be apparent to those skilled in the art from this disclosure that the components can be any type of structure and/or programming that can be used to carry out the present disclosure.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, "including", "having" and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the device for operating a vehicle. Accordingly, these terms, as utilized to describe the present disclosure should be interpreted relative to a vehicle equipped with the device for operating a vehicle.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device 10 includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present disclosure, it will be apparent to those skilled in the art from this disclosure that various changes and modifications can be made herein without departing from the scope of the disclosure as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further disclosures by the applicant, including the structural and/or functional concepts embodied by such feature(s). Thus, the foregoing descriptions of the embodiments according to the present disclosure are provided for illustration only, and not for the purpose of limiting the disclosure as defined by the appended claims and their equivalents.

What is claimed is:

1. A device for operating a vehicle, the device comprising:
a first communication device configured to connect to a remote server;
a second communication device configured to connect a vehicle control system of a vehicle; and
an electronic controller configured to download information from the remote server through the first communication device and provide the information to the vehicle control device through the second communication device, and configured to operate an aspect of the vehicle by sending an electronic control signal to the vehicle control system.

2. The device according to claim 1, further comprising a display device configured to display information downloaded from the server.

3. The device according to claim 1, wherein the second communication device includes a first connection unit configured to couple to a second connection unit disposed on the vehicle.

4. The device according to claim 1, wherein the second communication device is a wireless communication device configured to wirelessly communicate with the vehicle control system.

5. The device according to claim 1, further comprising a display device configured to enable a user to select the information to be downloaded from the remote server, the information being a set of data selected among a plurality of sets of data.

6. The device according to claim 5, wherein the display device is configured to display information related to the set of data.

7. The device according to claim 1, further comprising a plurality of buttons configured to operate the vehicle.

8. The device according to claim 1, further comprising a display device including an input configured to enable operation of the vehicle.

9. The device according to claim 1, further comprising a satellite location system configured to enable location of the device.

10. A method of operating a vehicle, the method comprising:
operating a device;
downloading information from a remote server using a first communication device of the device;
connecting the device to a vehicle;
providing the information to a vehicle control device using a second communication device;
sending a control signal from the device to operate an aspect of the vehicle.

11. The method according to claim 10, further comprising displaying information downloaded from the server on a display device.

12. The method according to claim 10, further comprising coupling the second communication device by a first connection unit a second connection unit disposed on the vehicle.

13. The method according to claim 10, wherein the providing the information to a vehicle control device using the second communication device includes wirelessly communicating with the vehicle control system.

14. The method according to claim 10, further comprising operating a display device on the device to select the information to be downloaded from the remote server, the information being a set of data selected among a plurality of sets of data.

15. The method according to claim 14, further comprising displaying information related to the set of data using the display device.

16. The method according to claim 10, further comprising operating at least one button of the device to operate the vehicle.

17. The method according to claim 10, further comprising operating a user input on a display device to operate the vehicle.

18. The method according to claim 10, further comprising locating the device using a satellite location system.
